(19) United States
(12) Patent Application Publication
(10) Pub. No.: US 2021/0356757 A1
(43) Pub. Date: Nov. 18, 2021

(54) METHOD AND DEVICE FOR HIGH-RESOLUTION FLUORESCENCE MICROSCOPY

(71) Applicants: FRIEDRICH-SCHILLER-UNIVERSITAET, Jena (DE); UNIVERSITAETSKLINIKUM JENA, Jena (DE)

(72) Inventors: Daniel WEIGEL, Jena (DE); Richard KOWARSCHIK, Schleiz (DE); Andreas STARK, Jena (DE); Lars SCHMIDL, Jena (DE); Christian GEIS, Jena (DE)

(21) Appl. No.: 17/284,348

(22) PCT Filed: Sep. 27, 2019
(86) PCT No.: PCT/EP2019/076248

§ 371 Date: Apr. 9, 2021

(30) Foreign Application Priority Data
Oct. 10, 2018 (DE) 10 2018 124 984.5

(51) Int. Cl. G02B 27/58; G02B 21/36; G01N 21/64; G02B 21/16; G02B 27/48

(52) U.S. Cl. CPC G02B 27/58; G02B 21/367; G02B 27/48; G02B 21/16; G01N 21/6458

(57) ABSTRACT

A method for high-resolution fluorescence microscopy, in which a number N of partial images of a specimen marked with fluorophores and excited to emit fluorescence are recorded, wherein the specimen is successively illuminated by N different effective illuminating patterns, a composite image is calculated from the partial images, the composite image having a higher structural resolution than the partial images, and the composite image is subsequently output, wherein each effective illuminating pattern is generated from the superimposition of at least two basic illuminating patterns, with the basic illuminating patterns differing from each other and for each partial image, and wherein the fluorophores contained in the sample are excited to emit fluorescence only where the at least two basic illuminating patterns superimpose to illuminate the sample, with the illumination superimposition of the at least two basic illuminating patterns releasing non-linear excitation and/or emission effects and/or switching effects in the fluorophores.

### PRIORITY CLAIM

The present application is a National Phase entry of PCT Application No. PCT/EP2019/076248, filed Sep. 27, 2019, which claims priority from German Patent Application 10 2018 124 984.5, filed Oct. 10, 2018, the disclosures of which are hereby incorporated by reference herein in their entirety.

### FIELD OF THE INVENTION

The invention relates to a method for high-resolution fluorescence microscopy and to a device that can be used in that method, wherein a specimen is marked by fluorophores. These fluorophores are excited to emit fluorescence, and a number of N partial images are recorded, from which a composite image is calculated that has a higher structural resolution than that achievable in the partial images.

### DESCRIPTION OF THE PRIOR ART

High-resolution microscopy, notably high-resolution fluorescence microscopy, has become an important tool for the examination especially of live specimens. In recording partial images, there is, due to refraction, a natural limit to resolution. In case of central illumination, e.g., this limit results from the proportion of the illuminating wavelength to the numerical aperture of the objective. Meanwhile, however, several methods have evolved that make it possible to reconstruct, from a number of partial images, an image having a resolution higher than the resolution criterion first posited by Abbe. Such methods use, e.g., confocal scanning or structured illumination. The specimens examined by these methods are usually marked by fluorescent dyes prior to microscopy. If the specimens so prepared are illuminated by appropriate excitation wavelengths, the fluorescent dyes, also known as fluorophores, are excited to spontaneously emit light.

One method for high-resolution fluorescence microscopy is known as the STED (Stimulated Emission Depletion) method. It is described, e.g., by S. Hell et al. In “Breaking the diffraction resolution limit by stimulated emission: stimulated-emission-depletion fluorescence microscopy”, published in Optics Letters 19 (11), 1 Jun. 1994, p. 780 ff. By targeted excitation and de-excitation of the light sources, i.e. the fluorophores, it is possible to reconstruct a highly resolved image. For that purpose, the object field is first scanned in a raster mode as common in confocal microscopy. Subsequently, the individual exposures can be assembled to obtain high-resolution imagery. One disadvantage is that scanning the point-shaped illumination raster is time-consuming; another drawback is that the high laser power used to achieve the best possible resolution puts a strain on the specimen.

On the other hand, there are wide-field methods such as in localization microscopy. In wide-field microscopy, the entire image field is illuminated at a time; fluorophores extant in that area are excited, and the entire image field is detected at the same time. In methods of localization microscopy, a minor percentage of the total extant quantity of fluorophores—or light sources in general—of every image is integrated in the detection process proper, whereas the greater portion of the fluorophores are in a state in which they do not emit any light. Within the images recorded, the centers of gravity of the various fluorophores are ascertained and then assembled to obtain a high-resolution composite image. As this amounts to a stochastic distribution of the excited states, the reconstruction of a high-resolution image requires several tens of thousands of individual images, as a rule. This sets a speed limit to the recording of each high-resolution image, which complicates the capturing of fast processes. Moreover, with exposure times too short, only such images are generated that contain identical structure information. One such localization microscopy method is known as the STORM (stochastic optical reconstruction microscopy) method; it is described, e.g., in a report by M. Rust et al., “Sub-diffraction-limit imaging by stochastic optical reconstruction microscopy (STORM)”, Nature Methods 3 (2006), p. 793 ff. To increase the probability of transfer of the fluorophores or light sources used into a state in which they do not emit light, such methods often use additional chemicals such as, e.g., (3-mercaptoethanolamine. In most cases, however, these chemicals are toxic to live specimens, which almost forecloses the recording of live processes over some length of time. Furthermore, localization microscopy is performed with high laser intensities of several kW/cm² on the specimen surface, which can be harmful to live tissue and cause premature bleaching of the fluorophores.

In their report “Fast, background-free, 3D super-resolution optical fluctuation imaging (SOH)”, published in PNAS 106 (52) (2009), p. 22287 ff., T. Dertinger et al. describe a method, which takes advantage of the fact that the response behavior of the fluorophores—the so-called “blinking response”—is statistic. Given an evenly illuminated object volume, this means that not all fluorophores respond simultaneously and/or with equal intensities. Here, high-resolution images of the object can be reconstructed by means of correlation algorithms. The blinking behavior itself shows a rather weak modulation, and the period during which the statistical behavior can be observed is preset by physics. Thus, the recording time is limited as well.

Whereas the methods described above make use of particular properties of the light sources, i.e., the fluorophores, in order to attain higher resolution, other methods are known in prior art, in which an increase in resolution is achieved by structured illumination, with the illumination structures being known. With previous knowledge about the illumination structures used, added information is gained from the recorded images. The method of structured illumination microscopy (SIM) is described, e.g., in DE 199 08 883 A1. Using an illumination structure with known properties, one can record spatial frequencies, which cannot be utilized in classical microscopy. For this purpose, though, the known structures have to be projected into the object space, and subsequently the recorded images have to be decomposed by means of appropriate algorithms in such a way that the higher spatial frequencies can be unambiguously assigned again. Further, harmonic frequencies can be generated in the object space so that the illuminating structure can be substantially reduced in size, which in turn improves the resolution of structured illumination microscopy, as described, e.g., by R. Heintzmann et al. in their report “Subdiffraction resolution in continuous specimens”, published in Nature Photonics 3, pp. 362-364 in 2009.

Further developments of these structured illumination methods allow unknown illumination structures to be used as well, as described in a report by S. Labouesse et al. “Fluorescence blind structured illumination microscopy: A new reconstruction strategy”, published in IEEE ICIP 2016, p. 3166 ff. Here, however, data analysis is more complex than in case of the SIM method with known structures.

Resolution can be further improved also by a special wide-field illumination, which evokes a non-linear response behavior of the fluorophores. Such a method is described by, e.g., M. Gustafsson et al. In their report “Nonlinear structured-illumination microscopy: Wide-field fluorescence imaging with theoretically unlimited resolution”, published in PNAS 102 (37), p. 13081 ff. on 13 Sep. 2005. Here, the specimen is illuminated with light the intensity of which fluctuates in a sinusoidal mode, with the intensity maximum being located near the absorption frequency of the fluorophores. Here again, data analysis requires a complex deconvolution algorithm to allow computation of the high-resolution image.

Where coherent light sources are used, one can create a structured illumination also with statistical or pseudostatistical patterns. The patterns created most easily are speckle distributions. These can be used for illuminating the object plane. They emerge if coherent light is directed, e.g., at a scattering object such as a diffuser disk, which gives the light a statistical phase distribution along its wavefront. After exiting the scattering object, different partial waves of the scattered wavefront superimpose and create, in the plane behind the scattering object, an interference pattern with bright and dark regions, depending on the phase differences of the partial waves. Due to their apparently granular illumination structure, these interference patterns are termed speckle patterns. The geometric size of the speckles emerging when the scattering object is imaged, i.e., the size of the areas of constant intensity within the speckle pattern depends on the numerical aperture of the imaging optics used, and the greater the numerical aperture (NA), the smaller are the speckles. With regard to their geometric extension, then, the speckles are diffraction-limited and thus cannot fall short of a minimum size depending on a coherent wavelength used for illumination.

In a report by M. Kim et al. “Superresolution imaging with optical fluctuation using speckle patterns illumination”, published in Scientific Reports 5 (2015), p. 16525 ff., the SOFI method described above is performed using illumination with speckle patterns. This permits, with comparatively little technical effort and without toxic chemicals, images to be recorded from which high-resolution reconstruction images of the specimens can be computed by means of known algorithms. This method, though, will not yield accuracies higher than about a quarter of the illuminating wavelength used.

U.S. Pat. No. 8,552,402 B2, finally, describes a setup in which a specimen is successively illuminated with various, statistically created speckle patterns, with the specimen being marked with common fluorescent dyes. Here, images are captured continuously, and a high-resolution image is reconstructed using suitable analysis algorithms, on the basis of the temporal changes of intensities in each pixel. Here, the minimum size of the speckle structures is in a linear relationship with the smallest detectable object structure. As the speckles are diffraction-limited regarding their size, the reconstruction accuracy of this method is also limited to extensions above a quarter of the illumination wavelength used.

### SUMMARY OF THE INVENTION

Departing from this, the problem of the invention is to develop a method that enables structures smaller than a quarter of the illuminating wavelength to be resolved without having to stress the specimen with toxic chemicals, the said method to be capable of generating a reconstructed high-resolution image with the least possible number of component images on the one hand, and with the least possible computation effort on the other hand.

This problem is solved by a method for high-resolution fluorescence microscopy, by which a number N of partial images of a specimen marked with fluorophores and excited to emit fluorescence are recorded, wherein the specimen is successively illuminated by N different effective illuminating patterns and wherein from the partial images, a composite image is calculated that features higher structural resolution than that of the partial images. The composite image is then output, i.e. displayed on a screen and/or stored. Each of the effective illuminating patterns is generated from the superimposition of at least two basic illuminating patterns, with the basic illuminating patterns differing both within any one partial image and from partial image to partial image. i.e., from each other, The fluorophores contained in the specimen are excited to emit fluorescence only where the at least two basic illuminating patterns are superimposed on each other to illuminate the specimen, in such a way that the illuminating superimposition of the at least two basic illuminating patterns triggers non-linear excitation and/or emission effects and/or switching effects in the fluorophores.

The basic illuminating patterns of each partial image differ from each other, i.e., two different basic illuminating patterns are superimposed. Moreover, the basic illuminating patterns also differ from partial image to partial image. So, for example, if N partial images with two basic illuminating patterns each are recorded, a total of 2N different basic illuminating patterns are applied.

Statistically produced speckle patterns are particularly well suitable as basic illuminating patterns. During the recording of a partial image they are constant, as a rule. It is also possible, though, to use speckle patterns that vary with time during the recording of a partial image. Moreover, it is possible to superimpose more than two speckle patterns in a partial image, which—depending on the fluorophores and non-linear processes or effects used—may lead to an additional size reduction of the effective illumination structure. Advisably, the at least two basic illuminating patterns are projected onto the specimen and superimposed there to create the effective illuminating pattern; i.e., the two basic illuminating patterns are, in principle, generated independently of each other and superimposed only in the object space, when focused on the specimen.

For that purpose, different non-linear excitation, emission and/or switching effects in the fluorophores can be used. These effects can be utilized separately or in combination by means of the effective illumination pattern.

It is possible to use, e.g., fluorophores that emit light only if the are excited by two or more photons of the same wavelength or of different wavelengths. The more wavelengths are needed for excitation, the smaller is the effective illumination structure, and the more stable is the resolution in the reconstructed image. In case of three fluorescence excitations, for which at least three photons have to hit the fluorophore in combination, three different basic illuminating patterns are superimposed.

An effective illumination structure according to the method described above can also be created by the application of nano particles and certain fluorophores, using the non-linear response behavior as a function of intensity. Here, use is made of the existing knowledge that nano particles and some fluorophores emit light only at and above a material-specific threshold level of illumination intensity. A reduction of the range in which this threshold intensity occurs in the effective illumination structure improves the lateral resolution. This can be achieved if, in a major portion of, say, more than 95% of the illuminated volume, there is a lower intensity, and only in less than 5% of the object region there is an intensity greater than or equal to the threshold intensity. These regions need to be sufficiently distanced from each other in space to enable the use of analysis algorithms for improving the resolution accuracy.

Other ways to create an effective illumination structure that is size-reduced compared to the basic illuminating patterns make use of bleaching and/or saturation effects of the fluorophores and nano particles in the object space, which are elicited by the irradiation of photons of the same and/or different wavelengths, wherein size reduction means that the effective, process-triggering illumination takes place in fewer places than it would in case of any of the unmixed basic illuminating patterns. Using bleaching effects, here, the effective illumination structure is influenced in that fluorophores within a series of measurements are converted into a bleached state, which may also be reversible. Thus, with an increasing number of images, it becomes less probable for fluorophores, once activated, to be activated again. This increases the probability for closely adjacent fluorophores to be activated individually and thus to become displayable if the number of images is adequately high, i.e. if more than 100 partial images are recorded. Furthermore, as in STED microscopy, stimulated bleaching of the excited state can be enforced by an additional illuminating pattern. This also leads to the generation of a smaller effective illumination pattern. The saturation of the fluorophores can be utilized inasmuch as, in the regions with an intensity far above the threshold intensity, the basic state of the fluorophores gets depopulated so that these can no longer participate in the fluorescence process. Due to this effect, the effective illuminated region becomes smaller, since only few fluorophores—less than 10%, as a rule—are still excitable from the basic state.

In an especially preferable version, the light sources used are photoconvertible and/or photoswitchable fluorophores, by which the specimen is marked first. With activating light of an activation wavelength, the photoswitchable fluorophores can be put into a state capable of fluorescein, and with excitation light of an excitation wavelength that is different from the activation wavelength they can be excited to emit fluorescence. After marking, therefore, the specimen is illuminated with coherent activating light, the activating light as the first basic illuminating pattern getting imparted with a first activation pattern. The first activation pattern is then projected onto the specimen, so that this, by the first activation pattern, is illuminated in a structured manner with activating light. The structure comprises bright and dark regions, which can be created by means of interference, thanks to the coherent illumination. In the bright regions, the specimen is illuminated, while in the dark ones it is not.

At the same time, the specimen is also illuminated with coherent excitation light, the excitation light as a second basic illuminating pattern getting imparted with a first excitation pattern, which differs from the first activation pattern. The first excitation pattern is then also projected onto the specimen. The projection (imaging) of the first activation pattern and the first excitation pattern can be performed by means of a microscope objective, for example. The specimen is then also illuminated with excitation light in a structured manner; here again, the structure consists of bright and dark regions resulting from the interference behavior.

Thus, the first activation pattern and the first excitation pattern are projected onto the specimen simultaneously, whereby they get superimposed on each other. As the two patterns differ, some regions are illuminated by the first activation pattern only, some others are not illuminated at all, and still others are illuminated both by the first activation pattern and the first excitation pattern, thus receiving light of both wavelengths. On account of the photoactivable fluorophores selected, then, fluorescence signals are emitted only by such fluorophores that are simultaneously illuminated by activating and excitation light, i.e., where illuminated regions of the first activation pattern and the first excitation pattern are superimposed. Again, for example, with the aid of the microscope objective, the fluorescence signals are then projected onto a flat-panel area detector, where they are recorded as intensity levels. From the recorded intensity levels, a partial image is generated first. On the assumption that the first activation pattern and the first excitation pattern illuminate regions of equal area, and that the shares of illuminated and non-illuminated partial regions are approximately equal for each pattern, it follows that, in the superimposition of the patterns differing from one another, the share of the region illuminated simultaneously by both patterns is smaller than the individual parts or regions. Altogether, then, fewer fluorophores are excited to emit fluorescence, i.e., the effective illumination structure is demagnified compared to the individual patterns.

After the recording of a partial image, at least the illumination by activating light is interrupted until the predominating share of the fluorophores has passed into a non-activated ground state. The predominating share is understood to mean that at least two thirds of the fluorophores, preferably 80%, but with particular preference at least 95% of the fluorophores have passed back to the ground state, in which they are not activated. Subsequently, a second activation pattern and a second excitation pattern are selected which also differ from each other as well as from the patterns used before. With these second patterns, the steps of recording a partial image are repeated. This process is repeated with further patterns as often as needed until a sufficient number of partial images have been recorded, from which the composite image, featuring higher structural resolution than the partial images, is calculated.

The effective illumination structure can be further reduced if the two regions occupied by the activation and excitation patterns in the specimen area overlap but to a minor extent, i.e. have an intersection of less than 50%, or preferably less than 20%, 10% or 5%. In that way, the region in which illuminations superimpose each other is further reduced.

The speckle patterns described above are particularly well suitable as activation and excitation patterns, as they are statistical patterns, which ensures that the superimposition pattern is statistical as well. Speckle patterns can be produced particularly easily with a diffuser disk. The preferred way of generating the first activation pattern and the first excitation pattern is to illuminate the same region of a diffuser disk in the illuminating ray path. The diffuser disk is projected into the entrance pupil of a microscope objective and from there onto the specimen. For generating the further activation and excitation patterns, the diffuser disk is rotated about an optical axis or shifted laterally relative to the said axis; here one should make sure that the spatial correlation between the speckle patterns generated is minimal. For the various activation and excitation patterns assigned to the respective partial images, one should preferably use non-overlapping regions of the diffuser disk.

In this procedure, the complete entrance pupil of the microscope objective should be illuminated so as to keep the extension of the speckles in the specimen plane as small as possible.

The invention also relates to a device for high-resolution fluorescence microscopy applied to a specimen marked by fluorophores, wherein the fluorophores are capable of fluorescein by non-linear excitation and/or emission processes, and/or by switching processes. Such a device comprises means for illumination and means for pattern generation with which, under illumination with the illuminating means, at least two different basic illuminating patterns are generated simultaneously. The device further comprises a microscope objective, with which the basic illuminating patterns are projected onto the specimen and superimposed upon each other to generate an effective illuminating pattern, and means for detection with a flat-panel array sensor, on which fluorescence signals emitted by the specimen are projected by means of the microscope objective and detected as a partial image. Finally, the device also comprises means for variation of the at least two basic illuminating patterns at least between two records of partial images and means for analysis to calculate a composite image from several of the recorded partial images. The device is particularly suitable for performing the method invented. For the said calculation from the partial images, the means for analysis may feature a suitable algorithm, e.g., of the type described by J. Min in his report “Fluorescent microscopy beyond diffraction limits using speckle illumination and joint support recovery”, published in Scientific Reports 3, p. 2075 in 2013. In toto, the 50 to 300 images of the specimen, recorded with different illuminations, will be sufficient.

The means for pattern generation preferably comprise a speckle generator. This may comprise a diffuser disk which, for varying the basic illuminating patterns, rotates about an optical axis or can be shifted perpendicularly to the said axis. As an alternative or a supplement, the speckles can be generated in a different way such as, for example, with an LCOS component (liquid crystal on silicon), a diffractive optical element (DOE), a microelectromechanical system (MEMS) or an acousto-optical modulator (AOM), or with any optically rough surfaces the roughness of which is greater than the wavelength of the illuminating light used. Electrically controllable elements can be addressed in such a way that they generate pseudostatistical patterns, which has the advantage of better reproducibility.

The means for illumination preferably comprise light sources adapted to radiate coherent light of two wavelengths. If photoswitchable fluorophores are used for marking, the light of the two wavelengths excites the fluorophores to emit fluorescence in the overlapped region, i.e., in the effective illuminating pattern where the at least two basic illuminating patterns superimpose each other to effect illumination. It is an advantage also if the device comprises means for interrupting the illumination of the specimen between the recording of two partial images for a specified period in the lower millisecond range of less than 400 ms, preferably less than 100 ms, to make it possible for the fluorophores to pass into a non-active ground state, before they possibly get illuminated by an activation pattern again.

It is understood that the features mentioned before and those to be explained below are applicable not only in the combinations stated but also in other combinations or as stand-alone features without leaving the scope of the present invention.

### BRIEF DESCRIPTION OF THE DRAWINGS

Below, the invention will be explained in more detail and exemplified with reference to the accompanying drawings, which also show features essential to the invention, among others, and in which

FIG. 1 the setup of a device for high-resolution fluorescence microscopy,

FIG. 2A)-C) the mode of operation of photoswitchable fluorophores, and

FIG. 3 the operating principle of recording high-resolution images.

### DETAILED DESCRIPTION OF THE DRAWINGS

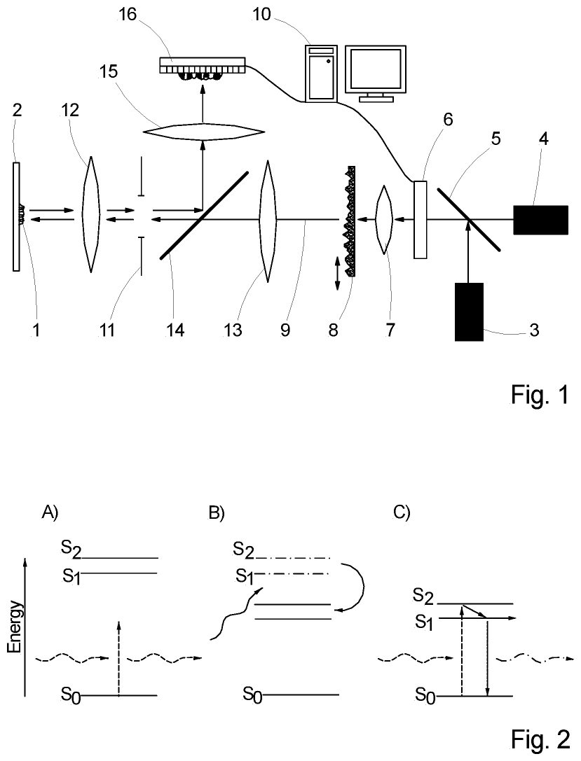

To start with, FIG. 1 shows a device with which a method for high-resolution fluorescence microscopy can be performed. In the exemplary embodiment shown here, a specimen 1 arranged on a specimen slide 2 is first marked by photoswitchable fluorophores. The device comprises means for illumination, viz two coherent light sources, an activation laser 3 and an excitation laser 4. The activation laser 3 radiates activating light of an activation wavelength, with which the fluorophores can be put into a state that enables them to fluoresce. The excitation laser 4 radiates excitation light of an excitation wavelength that differs from the activation wavelength. With this excitation wavelength, the fluorophores, once activated, can be put into a state that enables them to fluoresce. Instead of two different lasers one can use a broadband light source equipped with suitable filters.

The mode of operation of the photoswitchable fluorophores will now be explained in more detail in connection with FIG. 2, which shows the energy levels of such a fluorophore. In the deactivated ground state shown in FIG. 2A), The energy gap between the ground state S₀ and the excited state S₁ or S₂, respectively, cannot be bridged by illumination with light of the excitation wavelength, i.e., with excitation light; the energy is not absorbed, and no fluorescence is possible. Here, light of the excitation wavelength and the excitation energy are represented by arrows with dashed lines. Upon irradiation of the fluorophore molecules with activating light of the activation wavelength, as shown in FIG. 2B), the molecular structure of the fluorophore and, thus, the energy-level diagram changes. The two excitation levels S₁ and S₂ now have but a closer energetic distance to the ground state₀. Light of the activation wavelength is represented by the arrow with the solid, wavy line; in most cases, the activation wavelength is shorter than the excitation wavelength. Now, when the fluorophore is irradiated by excitation light of the excitation wavelength, as shown in FIG. 2C), light of this wavelength is absorbed. By means of a vibration relaxation between the excited states S₂ and S₁ and the subsequent fluorescence process between the excited state S₁ and the ground state S₀, the fluorescent dye molecule returns to the ground state S₀ once it has emitted light of the fluorescence wavelength, shown here by the dash-and-dot line.

For creating a high-resolution fluorescence image, a number N of partial images of the specimen marked by the fluorophores and excited to emit fluorescence are recorded. In this process, the specimen is successively illuminated with N different effective illuminating patterns, and a composite image is computed from the partial images, the said composite image having a higher structural resolution than the partial images. The composite image can then be read out. Each of the effective illuminating patterns is generated from the superimposition of at least two basic illuminating patterns, with the basic illuminating patterns being different from each other as well as for each partial image. On this condition, it is, in principle, possible also to choose activation wavelength and excitation wavelength to be equal, provided the fluorophores are selected accordingly.

In the above example, the specimen 1 is, on the one hand, illuminated by coherent activating light of the activation laser 3, wherein to the activating light, being the first basic illuminating pattern, a first activation pattern is imparted, which is projected onto the specimen, so that the specimen is illuminated in a structured mode by activating light. At the same time, the specimen 1 is illuminated by coherent excitation light of the excitation laser 4, wherein to the excitation light, being a second basic illuminating pattern, a first excitation pattern is imparted that differs from the first activation pattern. For that purpose, in the example shown in FIG. 1, the light of the activation laser 3 and the excitation laser 4 is directed via a dichroic beam splitter 5, an acousto-optical filter 6 and a lens 7 onto a diffuser disk 8, which can be laterally shifted perpendicularly to an optical axis 9 and/or rotated about the said axis. As a fluorescent dye, one can use, e.g., FLIP 565 made by Abberior GmbH; in this case, the wavelengths for activation and excitation are 375 nm and 561 nm, respectively.

Before a partial image is recorded, the acousto-optical filter 6, triggered by a computer 10, is switched to cause a region of the diffuser disk to be coherently illuminated with light both of the activation and of the excitation wavelength. The region on the diffuser disk should not be as large as to occupy the total diffuser disk, but rather as small as possible in order to keep spatial correlation between different partial images as low as possible. This correlation is the greater, the more regions of the diffuser disk appear in two or more images. Moreover, illumination of the diffuser disk 8 should take place in such a way that the entrance pupil 11 of a microscope objective 12 is illuminated as completely as possible, so that the speckles generated in the specimen plane have minimum extension, i.e. are diffraction-limited.

On account of the two different wavelengths of the laser light, two different illumination structures that vary statistically in space will form in the plane of the specimen 1, with the said two illumination structures being incoherent relative to each other, even though identical regions of the diffuser disk are illuminated. Because of illumination with the activation pattern, which is generated by the activating light of the activation laser 3, the fluorophores in the specimen 1 are, with spatial and statistical variation, put into a state capable of fluorescein. On account of the excitation pattern that is formed simultaneously by the laser light of the excitation laser 4, the fluorescent fluorophores capable of fluorescein are also excited to emit fluorescence, also with spatial and statistical variation. However, only such fluorophores will be excited to emit fluorescence, and actually do so, which are simultaneously illuminated by activation and excitation light, i.e. where the two basic illuminating patterns superimpose while illuminating the specimen 1. The illuminating patterns are projected into the entrance pupil 11 of the microscope 12 by means of an optical system 13. Fluorescence light emitted by the specimen is projected onto a flat-panel area detector 16, e.g. being a part of an EMCCD camera, by means of the microscope objective 12, another dichroic beam splitter 14, which separates the fluorescence light from the illumination light, and a tube lens 15. The fluorescence light detected by means of the flat-panel area detector 16, which is recorded in terms of intensity levels, is processed into a partial image by means of the computer 10.

After the recording of the first partial image and after the recording of every further partial image, the acousto-optical filter 6 is switched for no activating light and no excitation light reaching the specimen 1. This state is maintained long enough until a sufficient number, i.e., more than two thirds or, better, more than 80% of the fluorophores have returned to the non-fluorescent ground state. In the meantime, the diffuser disk 8 is moved into another position, e.g., by a stepper motor, as sketched out here by double arrows. Subsequently, the specimen 1 is illuminated as described above. The activation and excitation patterns formed now differ from the patterns used before as well as from each other, because the patterns are generated with different wavelengths, even though the same region is illuminated. Altogether, this leads in the specimen 1 to a fluorescence that varies statistically in space and differs from the fluorescence recorded before. Now another partial image is recorded, and after the recording of a total number of N images, where N may amount, e.g., to between 50 and 300, a high-resolution image of the specimen 1, each time illuminated in a different statistical variation in space, is calculated by an analyzing algorithm as mentioned above as an example, and displayed on a screen of the computer 10.

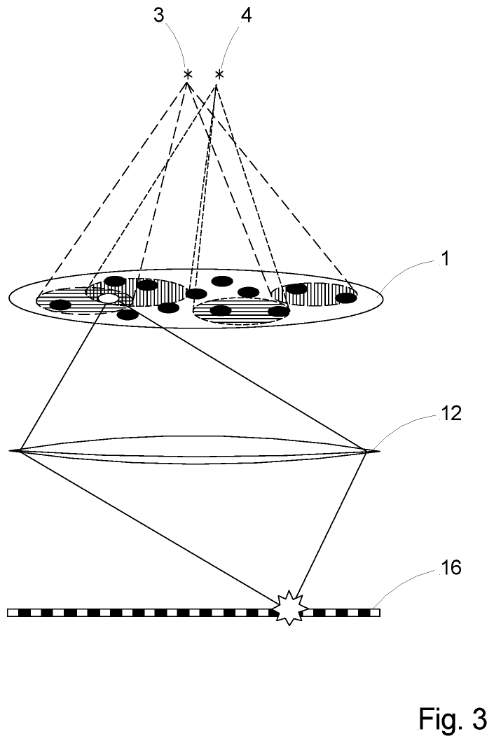

Below, the functional principle of pattern generation is explained in yet greater detail with the help of FIG. 3. On account of the structure of the activation pattern of the laser 3 (shown in FIG. 3 by horizontal hatching), a speckle pattern, only sporadic fluorescence molecules are put into a state capable of fluorescein in the specimen. The excitation pattern generated by the light of the excitation laser 4 (shown in FIG. 3 by vertical hatching), a second illuminating speckle pattern, has a different structure that is also varying in a different spatially statistical way, for which reason only part of the fluorescent molecules capable of fluorescein can actually be excited to emit fluorescence. The spatial region in the specimen 1, from which, after projection onto the flat-panel area detector 16 by the microscope objective 12, fluorescence light can be detected, results from the overlap region (shown in FIG. 3 by horizontal and vertical hatching); in the example shown in FIG. 3 there is only one single fluorophore, which is marked by a white circle. It is only in that overlap region that the fluorophores are actually activated and simultaneously excited to emit fluorescence. The fluorescence region, i.e., the overlap region, is smaller, as a rule, than the size of the speckle patterns used for illumination. This leads to a smaller effective illumination structure in the specimen 1 than would be possible with a conventional diffraction-limited structured illumination.

### LIST OF REFERENCE NUMBERS

1 specimen
2 specimen slide
3 activation laser
4 excitation laser
5 dichroic beam splitter
6 acousto-optical filter
7 lens
8 diffuser disk
9 optical axis
10 computer
11 entrance pupil
12 microscope objective
13 optical system
14 dichroic beam splitter
15 tube lens
16 flat-panel area detector

1. A method for high-resolution fluorescence microscopy, comprising:
recording a number of N partial images of a specimen marked by fluorophores and excited to emit fluorescence,
successively illuminating the specimen with N different effective illuminating patterns, and calculating a composite image from the partial images, the composite image having a higher structural resolution than the partial images, and outputting the composite image,
wherein each effective illuminating pattern is generated from the superimposition of at least two basic illuminating patterns, with the basic illuminating patterns differing from each other and for each partial image, and
wherein the fluorophores contained in the specimen are excited to emit fluorescence only where the at least two basic illuminating patterns superimpose to illuminate the specimen, with the illuminating superimposition of the at least two basic illuminating patterns triggering off non-linear excitation and/or emission effects and/or switching effects in the fluorophores.

2. The method as claimed in claim 1, wherein the basic illuminating patterns are generated statistically as speckle patterns.

3. The method as claimed in claim 2, wherein the speckle patterns change during the recording of a partial image.

4. The method as claimed in claim 1, wherein the at least two basic illuminating patterns are projected onto the specimen and there get superimposed to form the effective illuminating pattern.

5. The method for high-resolution fluorescence microscopy as claimed in claim 1, further comprising:
marking the specimen using photoswitchable fluorophores, which with activating light of an activation wavelength are put into a state capable of emitting fluorescence, and which with excitation light of an excitation wavelength that differs from the activation wavelength are excited to emit fluorescence,
illuminating the specimen with coherent activating light, wherein the activating light as the first basic illuminating pattern gets a first activation pattern imparted to it, and the first activation pattern is projected onto the specimen, so that this is illuminated by activating light in a structured mode, and simultaneously
illuminating the specimen with coherent excitation light, wherein the excitation light as a second basic illuminating pattern gets a first excitation pattern differing from the first activation pattern imparted to it, and the first excitation pattern is projected onto the specimen via a microscope objective, so that the specimen is illuminated by excitation light in a structured mode, for which reason fluorescence signals are emitted by such fluorophores only that are simultaneously illuminated by activation and excitation light,
projecting the fluorescence signals onto a flat-panel area detector and recording the projected fluorescence signals as intensity levels, from which a first partial image is generated,
interrupting the illumination at least with activating light until the predominating share of the fluorophores has passed into a non-activated ground state,
repeating the steps a through d with further activation patterns and further excitation patterns differing from each other, to generate further partial images.

6. The method as claimed in claim 5, wherein, for generating the first activation pattern and the first excitation pattern, in each case the same region of a diffuser disk in the illuminating ray path is illuminated, with the diffuser disk being projected into an entrance pupil of a microscope objective and from there onto the specimen, and that, for generating the further activation and excitation patterns, the diffuser disk is rotated about an optical axis or shifted laterally relative to this axis.

7. A device for high-resolution fluorescence microscopy applied to a specimen marked by fluorophores (1), wherein the fluorophores can, by non-linear processes or switching processes, be excited to emit fluorescence, comprising,
an illuminating device,
a pattern generator, with which, when they are illuminated by the illuminating device, at least two different basic illuminating patterns can be generated simultaneously, the pattern generator configured to vary the at least two basic illuminating patterns at least between two recordings of partial images,
a microscope objective configured to project and superimpose the basic illuminating patterns onto the specimen to form an effective illuminating pattern,
a flat-panel area detector, on which fluorescence signals emitted by the specimen are projected by the microscope objective and detected as a partial image, and
a computer for computing a composite image from a number of partial images.

8. The device as claimed in claim 7, wherein the pattern generator comprises a speckle generator.

9. The device as claimed in claim 8, wherein the speckle generator comprises LCOSs, DOEs, MEMSs, AOMs, at least one diffuser disk, and/or at least one object having an optically rough surface with a roughness greater than a longest wavelength of the light radiated by the illuminating device.

10. The device as claimed in claim 8, wherein the speckle generator comprises a diffuser disk, which, for varying the basic illuminating patterns, can be rotated about an optical axis or shifted perpendicularly to the optical axis.

11. The device as claimed in claim 7, wherein the illuminating device is adapted to radiate coherent light of two wavelengths, which in interaction with the effective illuminating pattern excite the fluorophores to emit fluorescence where the at least two basic illumination patterns superimpose to effect illumination.

12. The device as claimed in claim 7, wherein the device is configured such that the illumination of the specimen is interrupted for a specified period between the recordings of two partial images.
